(19) United States
(12) Patent Application Publication
(10) Pub. No.: US 2014/0030489 A1
(43) Pub. Date: Jan. 30, 2014

(54) OPTICAL RECORDING MEDIUM, AND MANUFACTURING METHOD OF OPTICAL RECORDING MEDIUM

(71) Applicant: Sony Corporation, Tokyo (JP)

(72) Inventor: Takeshi Miki, Tokyo (JP)

(21) Appl. No.: 13/932,687

(22) Filed: Jul. 1, 2013

(30) Foreign Application Priority Data
Jul. 27, 2012 (JP) 2012-167093

(51) Int. Cl. G11B 7/2403; G11B 7/26

(52) U.S. Cl. CPC G11B 7/2403; G11B 7/266
USPC 428/167; 428/697; 427/162

(57) ABSTRACT

There is provided an optical recording medium including a substrate, an information recording layer that is formed on the substrate, and has a recording film including a W oxide and an Fe oxide, and a light transmissive layer that is formed on the information recording layer.

### CROSS REFERENCES TO RELATED APPLICATIONS

The present application claims priority to Japanese Priority Patent Application JP 2012-167093 filed in the Japan Patent Office on Jul. 27, 2012, the entire content of which is hereby incorporated by reference.

### BACKGROUND

The present disclosure relates to an optical recording medium and a manufacturing method thereof.

In recent years, along with the distribution of personal computers, the advent and distribution of terrestrial digital broadcasting, and the acceleration of distribution of high-vision televisions in general households, optical discs, which are a kind of a medium of an optical information recording scheme, high density recording and large capacity. For example, CDs (Compact Discs), DVDs (Digital Versatile Discs), Blu-ray discs (BD, a registered trademark), and optical disc recording media that can record a larger amount of information thereon have been provided.

Furthermore, media that realize higher-density recording than current BDs have been proposed and developed in recent years as next-generation optical discs. See, for example, JP 2011-42070A and JP 2011-65722A.

### SUMMARY

In the field of such optical discs, streamlining of manufacturing processes and cost reduction have been greatly demanded.

For example, current Blu-ray discs each have an information recording layer with a structure having a recording film, a reflection film, and a dielectric film, and the like, but it is desirable to have as simple a film structure as possible.

On the other hand, for an information recording layer, a laser power margin, durability, and reliability that are sufficient for responding to high density recording also have to be secured.

It is desirable to manufacture an optical recording medium with excellent reliability that can respond to high density recording at low cost while having an information recording layer with a simple structure provided with three or fewer films.

According to an embodiment of the present disclosure, there is provided an optical recording medium including a substrate, an information recording layer that is formed on the substrate, and has a recording film including a W oxide and an Fe oxide, and a light transmissive layer that is formed on the information recording layer.

According to another embodiment of the present disclosure, there is provided a manufacturing method of an optical recording medium that includes a substrate, an information recording layer, and a light transmissive layer, the method including molding the substrate, forming the information recording layer on the substrate, and forming the light transmissive layer on the information recording layer. In the step of forming the information recording layer, formation of a recording film that includes a W oxide and an Fe oxide using sputtering is included.

According to the embodiment of the present disclosure, the information recording layer is set to have a structure having a recording film that includes tungsten (W) and iron (Fe) oxides, or for example, a film structure such as a single film structure only with a recording film, a dual or a triple film structure having a recording film and a protective film, and the like.

As a recording material that can be formed with a simple structure having three or fewer films including oxides, Zn—Pd—O, Zn—In—Pd—O, W—Pd—O, and the like using a palladium (Pd) oxide are considered. However, Pd is an expensive material. In order to realize a high SNR (Signal to Noise Ratio) of reproduction signals, and low production cost with high reliability, a film structure that does not use Pd is preferable. Based on the above point of view, the present inventor discovered a recording film having a tungsten (W) oxide and an iron (Fe) oxide as base components.

The recording film including a tungsten (W) oxide and an iron (Fe) oxide enables securing of sufficient laser power margin and response to high density recording.

According to the embodiments of the present disclosure described above, an optical recording medium having an information recording layer with a simple film structure can secure reliability and can respond to high density recording, and ensure cost reduction by using an inexpensive material for a recording film.

Additional features and advantages are described herein, and will be apparent from the following Detailed Description and the figures.

### BRIEF DESCRIPTION OF THE FIGURES

FIGS. 1A to 1C are illustrative diagrams of layer structures of an optical disc according to an embodiment of the present disclosure;

FIGS. 2A to 2D are illustrative diagrams of structures of an information recording layer according to an embodiment;

FIGS. 3A to 3D are illustrative diagrams of a manufacturing process of an optical disc according to an embodiment;

FIGS. 4A and 4B are flowcharts of manufacturing processes of optical discs according to an embodiment;

FIGS. 5A and 5B are illustrative diagrams of W:Fe composition ratio dependency according to an embodiment;

FIG. 6 is an illustrative diagram of oxygen flow rate dependency during film formation according to an embodiment;

FIGS. 7A and 7B are illustrative diagrams of a recording characteristic of a dual film structure according to an embodiment;

FIGS. 8A and 8B are illustrative diagrams of a recording characteristic of another dual film structure according to an embodiment;

FIGS. 9A and 9B are illustrative diagrams of a recording characteristic of a triple film structure according to an embodiment;

FIGS. 10A and 10B are illustrative diagrams of a recording characteristic of another triple film structure according to an embodiment;

FIGS. 11A and 11B are illustrative diagrams of a recording characteristic of still another triple film structure according to an embodiment;

FIGS. 12A and 12B are illustrative diagrams of reproduction durability and an archival characteristic according to an embodiment; and

FIG. 13 is an illustrative diagram of a high density recording characteristic according to the embodiment.

### DETAILED DESCRIPTION

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, preferred embodiments of the present disclosure will be described in the following order.

<1. Structure of an optical disc according to an embodiment>

<2. Manufacturing sequence>

<3. Characteristics of an optical disc according to the embodiment>

[3-1: Characteristics of a single film structure]

[3-2: Characteristics of a dual film structure]

[3-3: Characteristics of a triple film structure]

[3-4: Reliability, durability, and response to high recording density]

[3-5: Conclusion]

### 1. Structure of an Optical Disc According to an Embodiment

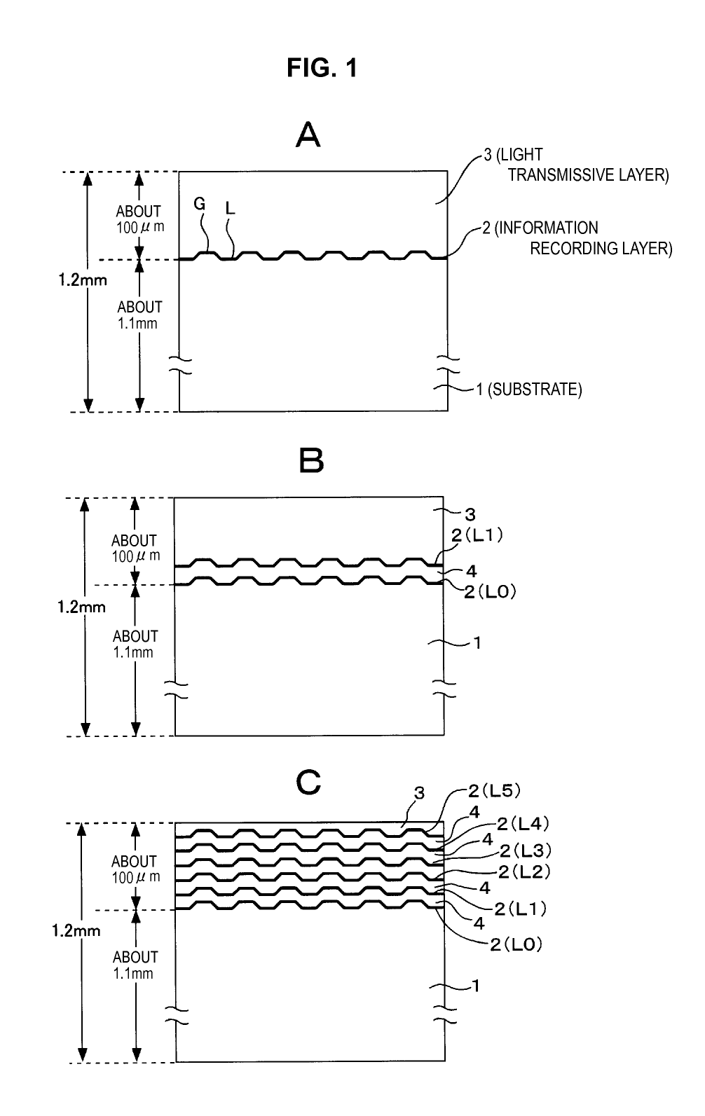

Layer structures of an optical disc according to an embodiment will be described using FIGS. 1A to 1C.

FIG. 1A schematically shows a layer structure of an optical disc with a single layer (which means that there is one information recording layer) according to an embodiment.

The optical disc of the present example is formed with an information recording layer 2 and a light transmissive layer (cover layer) 3 on one face of a discoid substrate 1 having a thickness of, for example, about 1.1 mm, and an outer diameter of about 120 mm.

It should be noted that the upper side of the drawing is a laser incident face on which laser light is incident during recording and reproduction.

The substrate 1 is formed of, for example, a polycarbonate resin in injection molding. In this case, the substrate 1 is formed while a concave/convex pattern of a stamper is transferred thereon by disposing the stamper in which the concave/convex pattern of wobbling grooves for tracking is transferred from a mastering original disk inside a mold. In other words, the substrate 1 on which the wobbling grooves which serve as recording tracks are formed is formed in an injection molding.

The information recording layer 2 is formed on one face of the substrate 1 formed in that manner, that is, on the face on which concaves and convexes serving as the wobbling grooves are formed. Thus, the information recording layer 2 is formed in a land/groove shape.

In the example, the information recording layer 2 is assumed to be formed with a single film structure, a dual film structure, or a triple film structure.

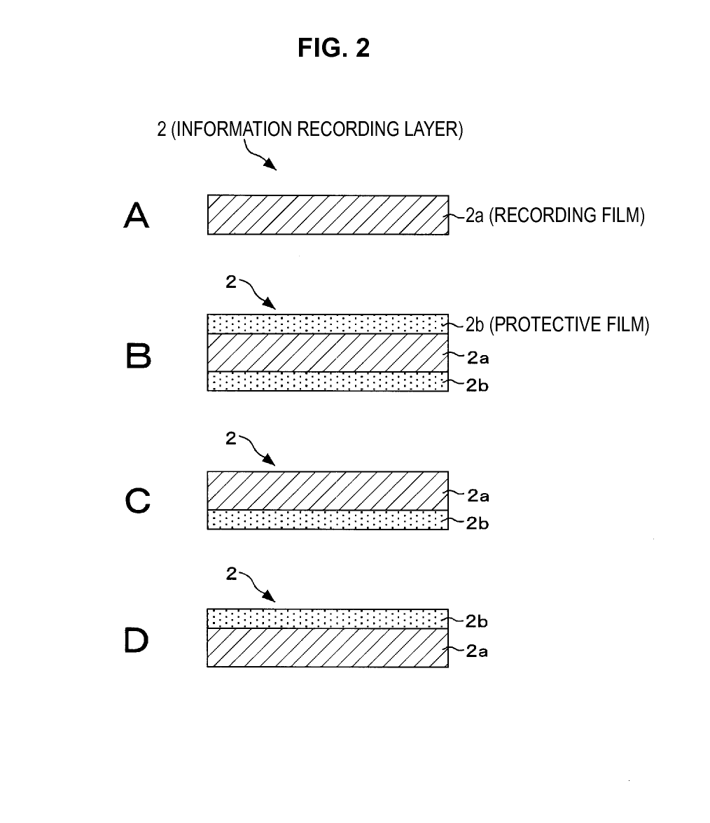

FIG. 2A shows the information recording layer 2 with a single film structure. In this case, a structure only with a recording film 2a is formed.

FIG. 2B is an example of a triple film structure. As shown in the drawing, an example in which the information recording layer 2 has a structure which has protective films 2b such as dielectric films, or the like on the upper and lower faces of the recording film 2a is also considered.

FIGS. 2C and 2D are examples of dual film structures. As in the examples, the examples of multiple film structures in which the protective films 2b such as dielectric films, or the like are provided on the upper face or the lower face of the recording film 2a are also considered.

The recording film 2a serving as the information recording layer 2 is formed using sputtering. In the example, the recording film 2a is formed as a film containing a tungsten (W) oxide and an iron (Fe) oxide. For example, a W—Fe—O recording film is formed using a sputtering method while allowing argon gas and oxygen gas to flow using a W—Fe alloy as a target.

The thickness of the recording film 2a is, for example, 40 nm or so.

In addition, as the recording film 2a, an oxide to which another element (X) is added in addition to W and Fe may be used. The other elements (X) include, for example, Al, Si, Ti, Zn, In, Sn, Zr, Ga, Mn, Ni, Cu, Pd, and Ag. The recording film 2a may be designed to contain an oxide including one or a plurality of elements selected from the above elements, in addition to the W oxide and the Fe oxide.

In addition, with regard to a W/Fe oxide or a W/(X)/Fe oxide included in the recording film 2a, it is preferable that the amount of oxygen be close to complete oxidization, or be complete or further oxidization in which an amount of oxygen greater than a stoichiometric composition is contained.

As shown in FIG. 1A, the upper face of the information recording layer 2 (on the laser radiated face side) is set to be the light transmissive layer 3.

The light transmissive layer 3 is formed to protect the optical disc. Recording and reproduction of information signals are performed in such a way that, for example, laser light is condensed on the information recording layer 2 through the light transmissive layer 3.

The light transmissive layer 3 is formed through curing using, for example, spin coating of a UV curable resin and UV irradiation. Alternatively, the light transmissive layer 3 can also be formed using a UV curable resin and a polycarbonate sheet, or an adhesive layer and a polycarbonate sheet.

The light transmissive layer 3 is formed to have a thickness of about 100 μm, and the total thickness of the optical disc with the substrate 1 having a thickness of about 1.1 mm is about 1.2 mm.

Although not shown in the drawings, it should be noted that there are also cases in which the surface (laser irradiation face) of the light transmissive layer 3 is processed with a hard coating to protect optical discs from, in particular mechanical impacts, scratches, and impression of fingerprints made when users handle the discs so as to ensure the quality of recording and reproducing information signals.

In the hard coating, a UV curable resin into which a fine silica gel powder is incorporated, a UV curable resin of solvent type, a UV curable resin of solventless type, or the like can be used to enhance mechanical strength.

In order to provide mechanical strength and repel oil and fat components coming from fingerprints, and the like, hard coating is performed to have a thickness from 1 μm to several μm.

FIGS. 1B and 1C show so-called multi-layered discs.

FIG. 1B is a dual layer disc on which layers L0 and L1 are provided as information recording layers 2.

FIG. 1C is a sextuple layer disc on which layers L0, L1, L2, L3, L4, and L5 are provided as information recording layers 2.

Intermediate layers 4 are set between the information recording layers 2.

Herein, a dual layer disc and a sextuple layer disc are exemplified, but the number of information recording layers 2 can, of course, be variously considered.

### 2. Manufacturing Sequence

A manufacturing sequence of an optical disc according to the embodiment will be described, exemplifying the single layer structure shown in, for example, FIG. 1A.

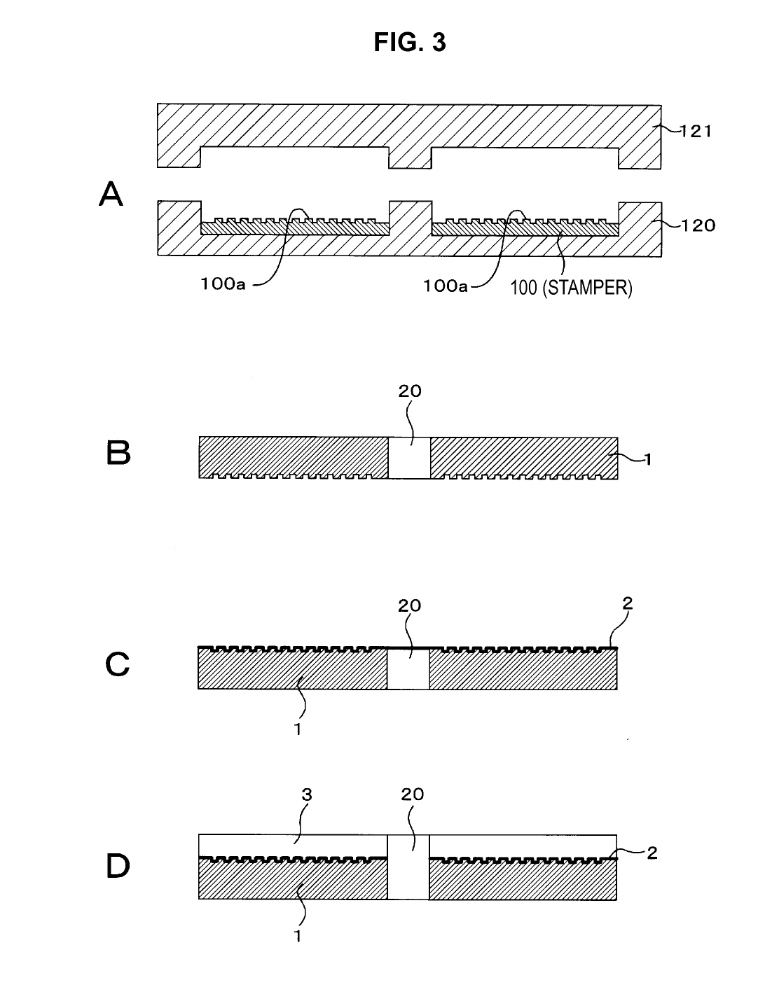

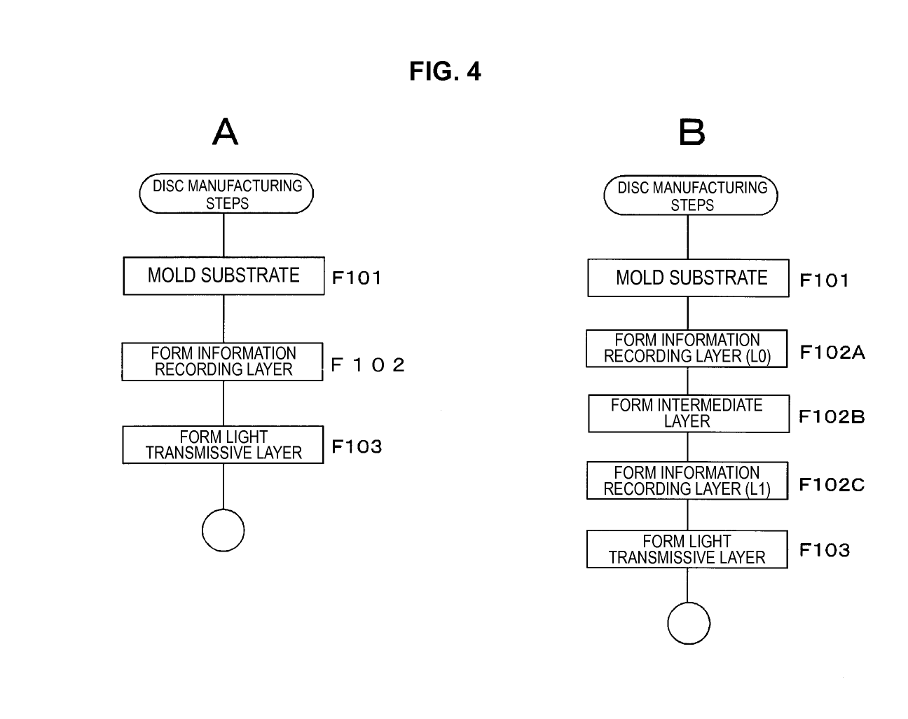

FIGS. 3A to 3D are schematic diagrams of each state in the course of an optical disc manufacturing process, and FIG. 4A is a flowchart describing the manufacturing steps.

It should be noted that, here, description will be provided from a step of creating the substrate 1 using a stamper, but prior to the step, the stamper is formed after steps of original disc mastering, development, and generation of a stamper.

In Step F101 of FIG. 4A, the substrate 1 is molded. For example, the substrate 1 of a molded resin is molded in injection molding using a polycarbonate resin. On the substrate 1 molded here, a concave/convex pattern that serves as recording tracks (wobbling grooves) on the information recording layer 2 is formed.

FIG. 3A schematically shows a mold to mold the substrate 1.

This mold includes a lower cavity 120 and an upper cavity 121, and in the lower cavity 120, a stamper 100 used to transfer the concave/convex pattern on the information recording layer 2 is disposed. On the stamper 100, the concave/convex pattern 100a to be transferred is formed.

The substrate 1 is molded in injection molding using such a mold, and the molded substrate 1 is formed as shown in FIG. 3B.

In other words, the substrate 1 that is made of a polycarbonate resin has a center hole 20 at the center thereof, and the concave/convex pattern that is transferred from the concave/convex pattern 100a formed on the stamper 100 in the mold is formed on one face of the substrate.

Next, in Step F102 of FIG. 4A, the information recording layer 2 is formed. In other words, on the concave/convex pattern of the substrate 1, the information recording layer 2 is formed using sputtering. FIG. 3C shows the state in which the information recording layer 2 is formed.

When the information recording layer 2 has a single film structure as shown in FIG. 2A, the recording film 2a is formed on the substrate 1 so as to have a thickness of, for example, about 40 nm. In this case, a W—Fe alloy, or a W—(X)—Fe alloy (where X is one or a plurality of elements selected from the additional elements described above) described above is used as a sputtering target. In addition, an Ar gas and an O₂ gas are introduced to perform reactive sputtering. Accordingly, the recording film 2a of a W—Fe oxide or of a W—(X)—Fe oxide described in FIGS. 2C and 2D is formed.

It should be noted that, in this step, reactive co-sputtering may be executed in such a way that each sputtering power is set using an independent W target, and Fe target, (and (X) target).

When the protective film 2b is formed on the upper and lower faces or on either face of the recording film 2a as shown in FIGS. 2B, 2C, and 2D, sputtering may also be performed to form the protective film 2b.

After the information recording layer 2 is formed in this manner, the light transmissive layer 3 is formed in Step F103 of FIG. 4A.

For example, a UV curable resin is spread on the face on which the information recording layer 2 is formed as shown in FIG. 3C in spin coating, and UV rays are radiated thereon so as to cure the resin. Accordingly, the light transmissive layer 3 is formed as shown in FIG. 3D.

Then, there is also a case in which hard coating is performed on the surface of the light transmissive layer 3. In addition, printing is performed on the face (leveled face) on the substrate 1 side. Then, after an inspection, an optical disc, for example, a readable disc is completed.

FIG. 4B shows manufacturing steps of the dual layer disc shown in FIG. 1B. After a substrate is molded in the same manner as in the single layer disc of FIG. 4A (in Step F101), the formation of an information recording layer as the layer L0 (in Step F102A), the formation of an intermediate layer (in Step F102B), and the formation of another information recording layer as the layer L1 (in Step F102C) are performed, and then, the formation of a light transmissive layer (in Step S103) is performed.

In the steps of forming the information recording layers in Steps F102A and F102C, Ar gas and O₂ gas are introduced to perform reactive sputtering (or reactive co-sputtering) targeting a W—Fe alloy or a W—(X)—Fe alloy, and the recording film 2a is thereby formed. In a dual film structure, and a triple film structure, the protective film 2b is also formed.

The step of forming the intermediate layer in Step F102B is performed in such a way that, for example, a UV curable resin is spread using spin coating, UV rays are radiated, and thereby the resin is cured.

In the steps of FIG. 4B, the dual layer disc of the embodiment can be manufactured.

In addition, although description is not provided, in the formation of an optical disc with three or more layers, such as the sextuple layer disc of FIG. 1C, the steps of forming the information recording layers and the intermediate layers are repeated a necessary number of times.

It should be noted that, in a multilayer disc having two or more layers, the composition ratio of the recording film 2a may be varied for each of information recording layers 2 (L0, L1, L2, . . . Ln). For example, as will be described later, transmittance changes according to the content of Fe. As the content of Fe is large, transmittance decreases. On the other hand, as the content of Fe is large, absorption increases, and thus, recording sensitivity increases.

In the case of a multilayer disc, higher transmittance is necessary for information recording layers 2 disposed closer to a laser incident face, and thus, it is preferable that a content ratio of Fe decreases from the layer L0 disposed on the innermost side to the layer Ln disposed on the outermost side.

By manufacturing an optical recording medium in the manner described above, the optical recording medium with high density which realizes improvement in manufacturing efficiency and cost reduction while maintaining reliability can be provided.

Cost for materials can be drastically reduced by using Fe. In addition, particularly a single film structure can be easily prepared in one sputtering chamber, which is effective in reducing cost and processing time.

In addition, an optical disc using the recording film 2a with a W—Fe oxide (or a W—(X)—Fe oxide) gains high reliability, and can respond to high density recording.

### 3. Characteristics of an Optical Disc According to the Embodiment

### 3-1. Characteristic of a Single Film Structure

Hereinafter, characteristics elicited from various measurement results obtained when the recording film 2a is formed as a W—Fe oxide or a W—(X)—Fe oxide will be described.

First, a case in which the information recording layer 2 has a single film structure (the structure of FIG. 2A) with the recording film 2a will be described.

Recording characteristics of the case of the single film structure, a laser power margin and composition ratio dependency of W and Fe have been examined. As experimental samples for the examination, three types of optical discs having the information recording layer 2 with the single film structure of the recording film 2a of a W—Fe oxide (W—Fe—O) were prepared.

The three types of samples respectively have the composition ratios (W:Fe) of W and Fe of 50:50, 60:40, and 70:30.

In addition, during the formation of the recording film 2a for each sample, a W—Fe alloy was used as a target, and sputtering power was set to be 500 W, the flow rate of an Ar gas to be 30 sccm, and the flow rate of an O₂ gas to be 50 sccm.

The thickness of the recording film 2a was set to be 40 nm.

The quality of signals performing recording and reproduction was evaluated for the three types of samples described above under the following recording and reproduction conditions.

With regard to a recording operation, one track was recorded on sample optical discs for data that had undergone RLL (1,7) PP modulation (Run Length Limited, Parity preserve/Prohibit rmtr (repeated minimum transition run-length)). In other words, the samples were in the state in which reproduction signals with no crosstalk were obtained.

A channel bit rate was 264 Mbit/sec. This corresponds to a quadruple speed of a BD.

A linear velocity was 14.0 m/sec.

A track pitch was 0.32 μm to perform groove recording.

In signal processing, PR (2, 3, 3, 3, 2) of a partial response maximum likelihood decoding process (PRML detection scheme: Partial Response Maximum Likelihood Detection Scheme) was used.

Reproduction laser power when recorded information was reproduced was set to be 1.5 mW to perform reproduction at a quadruple speed.

As evaluation indexes, values of i-MLSE that is an optical disc evaluation technique using the PRML detection scheme, and bit error rates were used.

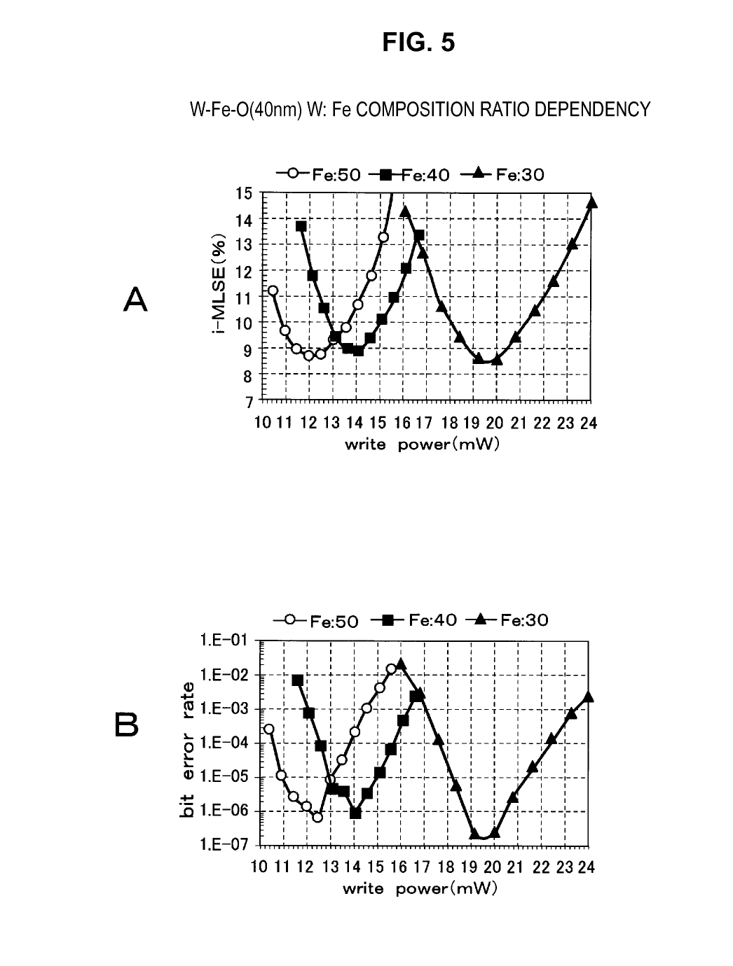

The vertical axis of FIG. 5A indicates values of i-MLSE and the horizontal axis thereof indicates recording laser power. The vertical axis of FIG. 5B indicates bit error rates, and the horizontal axis thereof indicates recording laser power.

For the three types of samples, the composition ratios of Fe were denoted as “Fe:50,” “Fe:40,” and “Fe:30.”

As understood from FIG. 5A, the bottoms of i-MLSE of all samples with Fe:50, Fe:40, and Fe:30 are lower than or equal to 9%. For example, a BD is regarded as favorable when the value of a bottom thereof is 11% or lower, and a reference power margin is considered to be 13% to 14%, and thus, all samples are regarded to obtain favorable reproduction signal characteristics, and to have a sufficient recording laser power margin.

Even with regard to bit error rates as shown in FIG. 5B, the value of a bottom thereof reaches around the negative sixth power (1×10⁻⁶), values are clear around the negative fourth power (1×10⁻⁴), and thereby satisfactory signal quality is attained. The power margin of recording laser power is also sufficient.

Here, when composition ratio dependency is considered comparing the samples of Fe:50, Fe:40, and Fe:30, it is found that, as the composition ratio of Fe becomes lower, higher power for recording laser power is necessary.

In the case of the W—Fe oxide, W contributes to transmittance, and Fe contributes to absorption. In other words, while recording sensitivity increases as the content ratio of Fe becomes higher, transmittance increases as the content ratio of W becomes higher.

From this point, it is preferable to set the content ratio of W—Fe considering appropriate recording sensitivity and transmittance for the recording film 2a of the optical disc. In other words, transmittance and absorption characteristics of the recording film 2a can be designed according to the W—Fe composition ratio.

In addition, in the case of a multilayer optical disc as shown in FIGS. 1B and 1C, adjusting the W—Fe composition ratio for each layer is also considered.

For example, while it is necessary for layers closer to the laser incident face to have higher transmittance, it is proper for layers on the further inner side from the laser incident face to have higher recording sensitivity. Thus, it is also preferable to design an optical disc such that the layer L0 on the innermost side has the highest composition ratio of Fe, and layers closer to the laser incidence face have lower composition ratios of Fe.

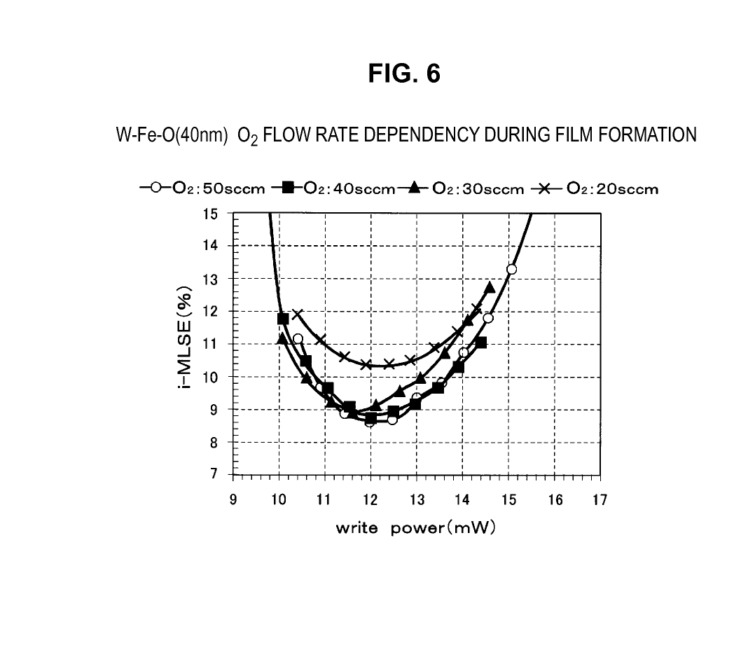

Next, in FIG. 6, O₂ flow rate dependency during film formation when the information recording layer 2 has a single film of the W—Fe oxide in the same manner will be described.

As samples, four types of optical discs of which the information recording layer 2 has a single film structure with the recording film 2a of the W—Fe oxide (W—Fe—O) were prepared.

For the recording film 2a of each sample, the composition ratio of W and Fe was set to be W:Fe=50:50. Then, during the formation of the recording film 2a of each sample, a W—Fe alloy was used as a target, and sputtering power was set to be 500 W, and the flow rate of an Ar gas to be 30 sccm as above, but the flow rates of an O₂ gas of the samples were set to be 50 sccm, 40 sccm, 30 sccm, and 20 sccm. The thickness of the recording film 2a was 40 nm.

The same recording and reproduction conditions were set as described above.

Then, values of i-MLSE with respect to recording laser power were measured.

As understood from FIG. 6, in the samples that have the high oxygen flow rates (of 50 sccm and 40 sccm) during sputtering, reproduction signal quality with favorable bottom values and power margins was attained.

The sample with the oxygen flow rate of 30 sccm had a slightly high bottom value.

The sample with the oxygen flow rate of 20 sccm had a relatively high bottom value, and a narrow power margin.

Based on the results, supplying sufficient oxygen during sputtering is considered to be proper. In other words, for the W—Fe oxide included in the recording film 2a, the amount of oxygen is preferably close to complete oxidation, or preferably greater than complete oxidation with an amount of oxygen greater than a stoichiometric composition contained.

### 3-2: Characteristics of a Dual Film Structure

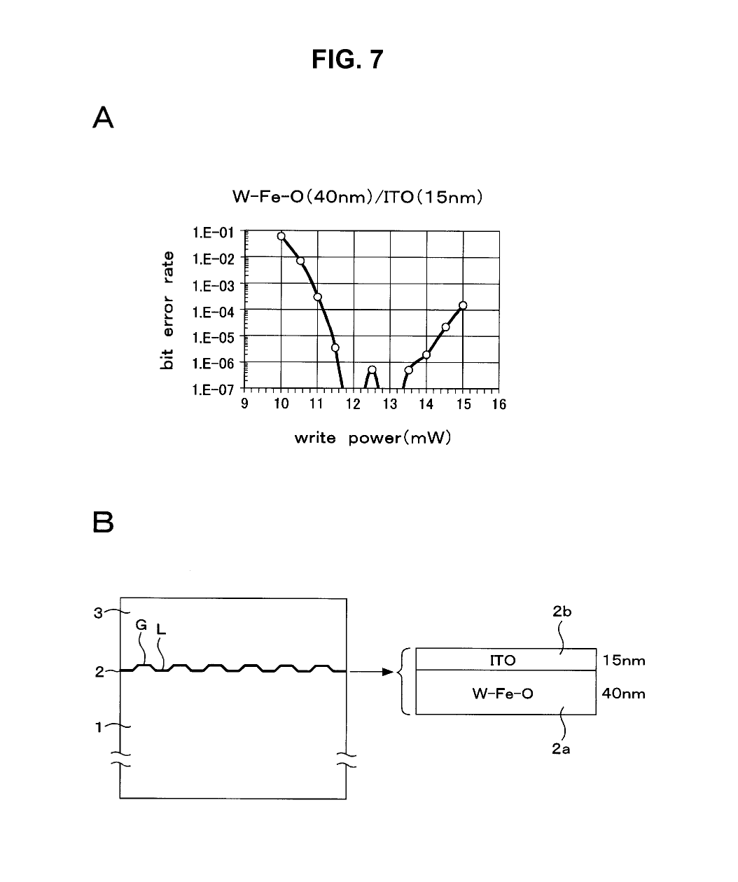

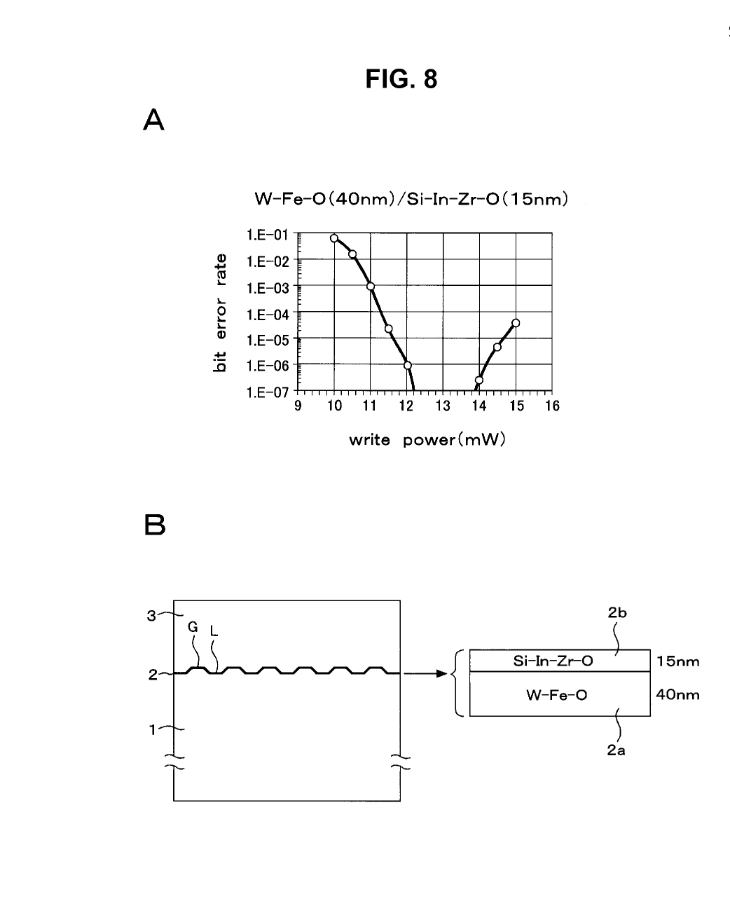

Next, an example in which the information recording layer 2 has a dual film structure of the recording film 2a and the protective film 2b (the structure of FIG. 2D) will be described with reference to FIGS. 7A, 7B, 8A, and 8B.

FIG. 7A shows measurement results of bit error rates with respect to recording laser power of a sample with the created dual film structure.

The sample in this case is assumed to include the information recording layer 2 including the recording film 2a of a W—Fe oxide (W—Fe—O) and the protective film 2b of an ITO as shown in FIG. 7B.

Generation conditions of the sample are as follows.

| | |
|---|---|
| Composition ratio of the recording film 2a | W:Fe = |
| | 50:50 |
| Thickness of the recording film 2a | 40 nm |
| Sputtering power during the formation of the recording film | 500 W |
| Flow rate of an Ar gas during the formation of the | 40 sccm |
| recording film | |
| Flow rate of an O₂ gas during the formation of the | 50 sccm |
| recording film | |
| Material of the protective film 2b | ITO (Indium |
| | tin oxide) |
| Thickness of the protective film 2b | 15 nm |
| Sputtering power during the formation of the protective film | 2 kW |
| Flow rate of an Ar gas during the formation of the | 70 sccm |
| protective film | |
| Flow rate of an O₂ gas during the formation of the | 2 sccm |
| protective film | |

FIG. 8A shows measurement results of bit error rates with respect to recording laser power of a sample with another dual film structure. This sample is assumed to include the information recording layer 2 including the recording film 2a of a W—Fe oxide (W—Fe—O) and the protective film 2b of Si—In—Zr—O as shown in FIG. 8B.

Conditions for generating the recording film 2a of the sample of FIGS. 8A and 8B are the same as for the sample of FIGS. 7A and 7B. Conditions for generating the protective film 2b are as follows.

| | |
|---|---|
| Material of the protective film 2b | Si—In—Zr—O |
| Thickness of the protective film 2b | 15 nm |
| Sputtering power during the formation of the protective | 2 kW |
| film | |
| Flow rate of an Ar gas during the formation of the | 70 sccm |
| protective film | |

Recording and reproduction conditions of the samples of FIGS. 7A, 7B, 8A, and 8B in order to measure bit error rates thereof are the same as those during the measurement of FIGS. 5A and 5B as follows.

Recording signal . . . 1 track recording of data that has undergone RLL (1,7) PP modulation

| | |
|---|---|
| Channel bit rate | 264 Mbit/sec |
| Linear velocity | 14.0 m/sec |
| Track pitch | 0.32 μm |
| Reproduction signal process | PR (2, 3, 3, 3, 2) |
| Reproduction operation | laser power of 1.5 mW, reproduction |
| | of a BD at a quadruple speed |

As understood from FIGS. 7A and 8A, all of the samples have sufficiently low bottom values of the bit error rate, and a wide power margin at the level of, for example, 1×10⁻⁴. Thus, the information recording layer 2 having the recording film 2a of the WFe oxide and the protective film 2b also obtains satisfactory quality of reproduction signals.

### 3-3: Characteristics of a Triple Film Structure

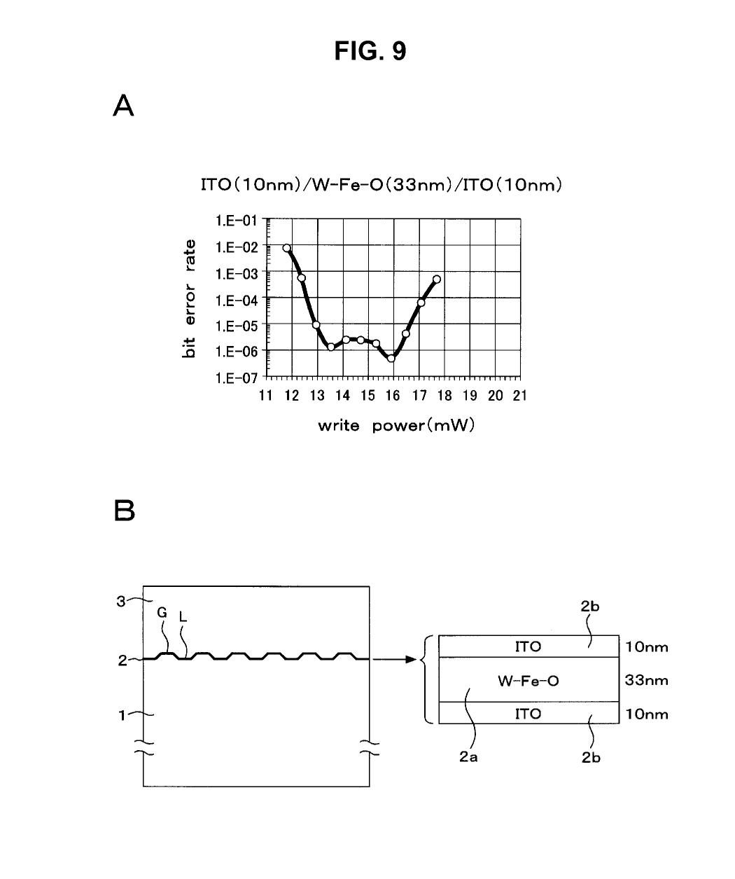

Next, a triple film structure in which the information recording layer 2 has the recording film 2a and the protective films 2b on the upper and lower faces of the recording film (the structure of FIG. 2B) will be described with reference to FIGS. 9A, 9B, 10A, 10B, 11A, and 11B.

FIG. 9A shows measurement results of bit error rates with respect to recording laser power of a created sample with the triple film structure.

As shown in FIG. 9B, the sample in this case is assumed to include the information recording layer 2 including the recording film 2a of a W—Fe oxide (W—Fe—O) and the protective films 2b of ITO on the upper and lower faces of the recording film.

Conditions for generating the sample are as follows.

| | |
|---|---|
| Composition ratio of the recording film 2a | W:Fe = |
| | 50:50 |
| Thickness of the recording film 2a | 33 nm |
| Sputtering power during the formation of the recording film | 500 W |
| Flow rate of an Ar gas during the formation of the | 40 sccm |
| recording film | |
| Flow rate of an O₂ gas during the formation of the | 50 sccm |
| recording film | |
| Material of each protective film 2b | ITO (Indium |
| | tin oxide) |
| Thickness of each protective film 2b | 10 nm |
| Sputtering power during the formation of each protective | 2 kW |
| film | |
| Flow rate of an Ar gas during the formation of each | 70 sccm |
| protective film | |
| Flow rate of an O₂ gas during the formation of each | 2 sccm |
| protective film | |

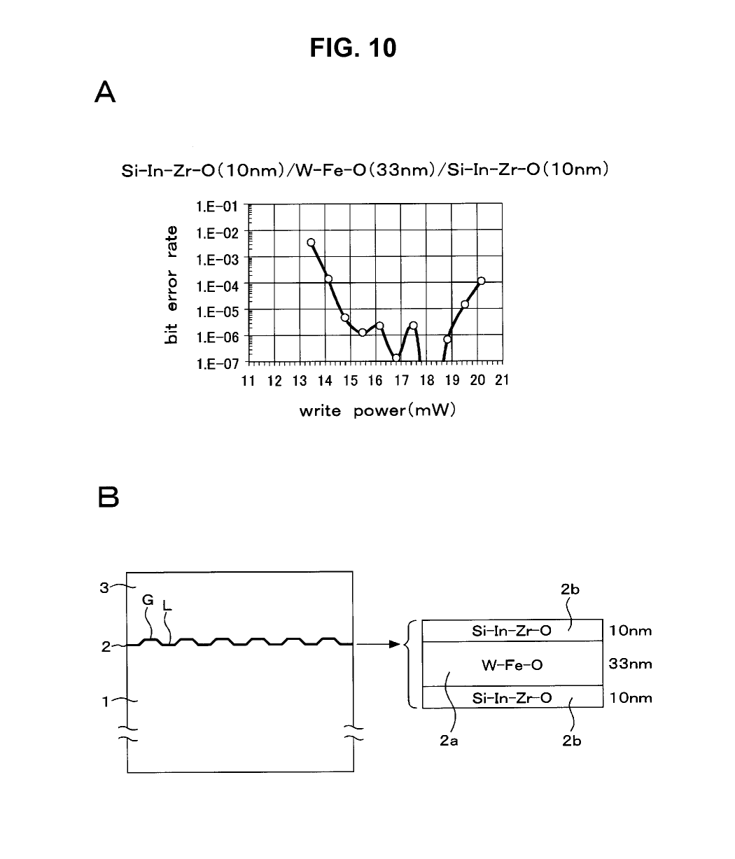

FIG. 10A shows measurement results of bit error rates with respect to recording laser power of a sample with another triple film structure. As shown in FIG. 10B, this sample is assumed to include the information recording layer 2 including the recording film 2a of a W—Fe oxide (W—Fe—O) and the protective films 2b of Si—In—Zr—O on the upper and lower faces of the recording film.

Conditions for generating the recording film 2a of the sample of FIGS. 10A and 10B are the same as those of the sample of FIGS. 9A and 9B. Conditions for generating the protective films 2b are as follows.

| | |
|---|---|
| Material of each protective film 2b | Si—In—Zr—O |
| Thickness of each protective film 2b | 10 nm |
| Sputtering power during the formation of each protective | 2 kW |
| film | |
| Flow rate of an Ar gas during the formation of each | 70 sccm |
| protective film | |

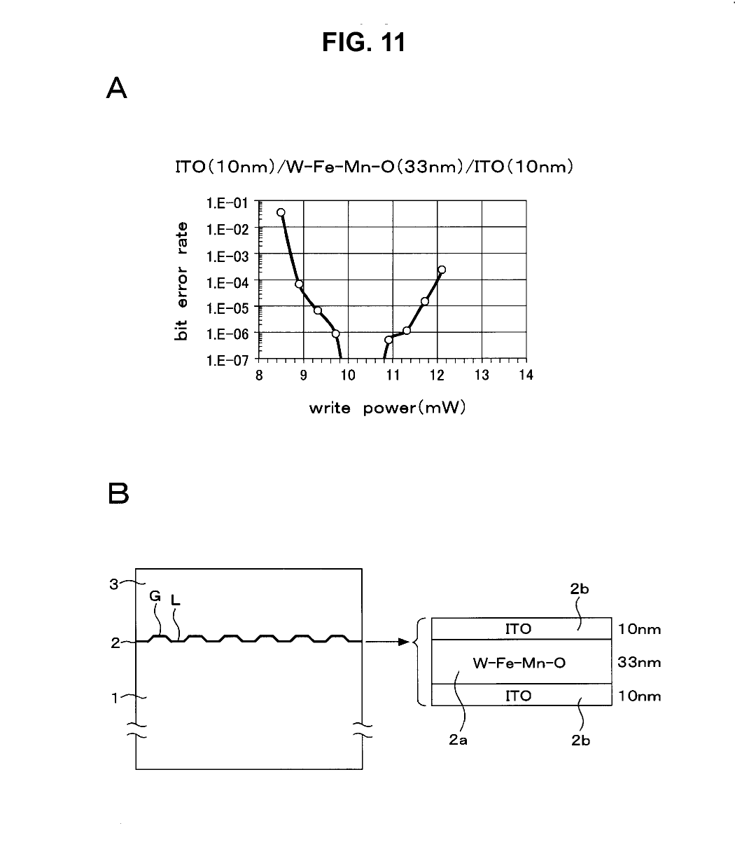

FIG. 11A shows measurement results of bit error rates with respect to recording laser power of a sample with still another triple film structure. As shown in FIG. 11B, this sample is assumed to include the information recording layer 2 including the recording film 2a of a W—Fe—Mn oxide (W—Fe—Mn—O) and the protective films 2b of ITO on the upper and lower faces of the recording film.

Conditions for generating the protective films 2b of ITO of the sample of FIGS. 11A and 11B are the same as those of the sample of FIGS. 9A and 9B. Conditions for generating the recording film 2a are as follows.

| | |
|---|---|
| Composition ratio of the recording film 2a | W:Fe:Mn = |
| | 35:35:30 |
| Thickness of the recording film 2a | 33 nm |
| Sputtering power during the formation of the recording film | 500 W |
| Flow rate of an Ar gas during the formation of the | 40 sccm |
| recording film | |
| Flow rate of an O₂ gas during the formation of the | 50 sccm |
| recording film | |

Recording and reproduction conditions of each of the samples of FIGS. 9A, 9B, 10A, 10B, 11A, and 11B in order to measure bit error rates thereof are the same as those during the measurement of FIGS. 5A, 5B, 6, 7A, 7B, 8A, and 8B as described above.

As understood from FIGS. 9A, 10A, and 11A, all of the samples have sufficiently low bottom values of the bit error rate, and a wide power margin at the level of, for example, 1×10⁻⁴. Thus, the information recording layer 2 with the triple film structure having the recording film 2a of the W—Fe oxide and the protective films 2b also obtains satisfactory quality of reproduction signals.

For the sample of FIGS. 11A and 11B, the recording film 2a is set to be a W—(X)—Fe oxide, and (X) is set to be Mn, but a case in which an additional element is added to W and Fe in this manner also obtains favorable characteristics. It should be noted that Mn is considered to boost the function of Fe, that is, the function of light absorption, and accordingly to contribute to improvement of recording sensitivity.

### 3-4: Reliability, Durability, and Response to High Recording Density

Next, reliability, durability and response to high recording density will be described.

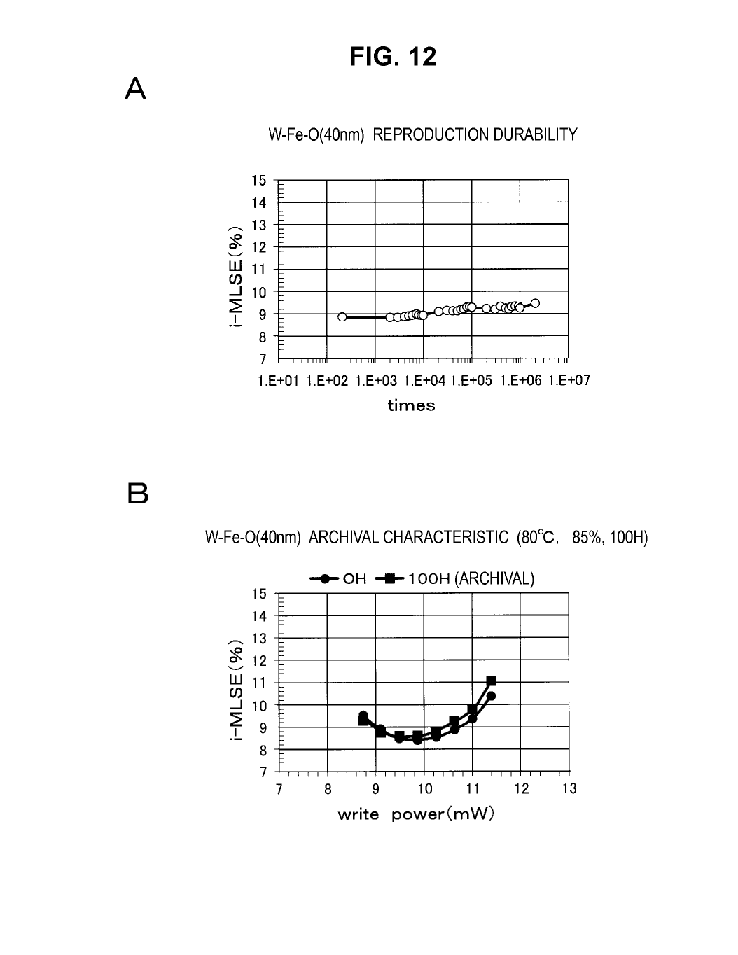

FIG. 12A shows results of examination of reproduction durability using a sample with a single film structure including the recording film 2a of a W—Fe oxide.

Conditions for generating the recording film 2a of the sample are as follows.

| | |
|---|---|
| Composition ratio of the recording film 2a | W:Fe = 50:50 |
| Thickness of the recording film 2a | 40 nm |
| Sputtering power during the formation of the recording | 500 W |
| film | |
| Flow rate of an Ar gas during the formation of the | 30 sccm |
| recording film | |
| Flow rate of an O₂ gas during the formation of the | 50 sccm |
| recording film | |

Recording and reproduction conditions are the same as those during the measurement of FIGS. 5A to 11B. In order to examine reproduction durability, reproduction was performed 2 million times, and i-MLSE during reproduction was measured.

As shown in FIG. 12A, while the values of i-MLSE slightly deteriorated as reproduction was repeated, the value was about 9.5% even when reproduction was performed 2 million times, showing a satisfactory result for durability.

FIG. 12B shows results of examination of an archival characteristic of a sample generated under the same condition as those of FIGS. 11A and 11B. Recording and reproduction conditions are the same as those of each examination described above.

In this examination, recording was performed on an optical disc serving as a sample, then the optical disc was left under the environment of a temperature of 80° C. and humidity of 85% for 100 hours, and then reproduction thereof was performed.

FIG. 12B shows i-MLSE measurement results (0 H) during reproduction before disposition thereof under the environment of high temperature and humidity and i-MLSE measurement results (100 H) after 100 hours under the environment of high temperature and humidity. As shown in the drawing, although it was found that the measurement values after 100 hours elapsed slightly deteriorated, the values were at the level at which there is no problem in practical use.

Based on the results shown in FIGS. 12A and 12B above, it is regarded that reliability and durability sufficient for practical use are obtained even when the information recording layer 2 has a single film structure including the recording film 2a of a W—Fe oxide.

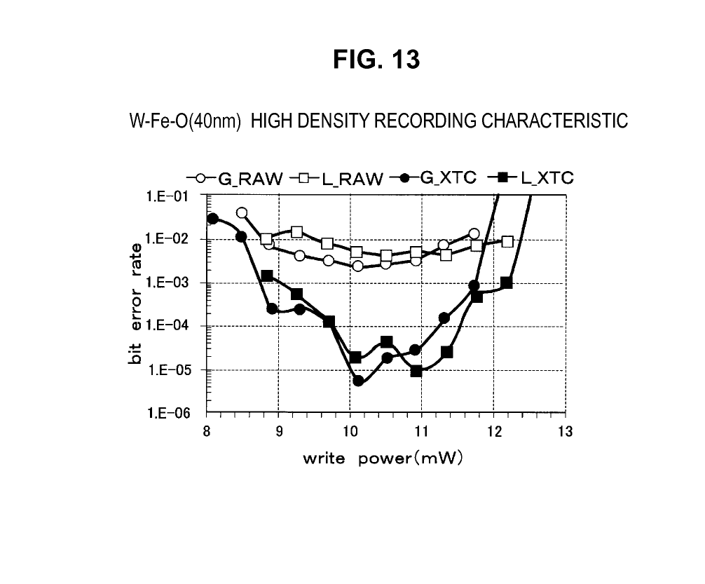

Next, a high density recording characteristic will be described. FIG. 13 shows results of examination of a possibility of an optical disc with the same single film structure as that of FIGS. 12A and 12B responding to high density recording.

Recording and reproduction conditions for measuring bit error rates are as follows.

| | |
|---|---|
| Recording signal | Consecutive recording of data that has |
| | undergone RLL (1,7) PP modulation onto a |
| | plurality of tracks (recording in a state in |
| | which crosstalk occurs) |
| Channel bit rate | 264 Mbit/sec |
| Linear velocity | 14.0 m/sec |
| Track pitch | 0.225 μm (performing land/groove recording |
| | on a recording face with a groove pitch |
| | of 0.45 μm) |
| Reproduction signal process | PR (2, 3, 3, 3, 2) and a crosstalk cancellation |
| | process |
| Reproduction operation | laser power of 1.5 mW, reproduction of |
| | a BD at 4x speed |

It should be noted that the recording conditions (channel bit rate, linear velocity, and track pitch) in this case are for recording density that realizes 50 GB per layer on a disc with a diameter of 120 mm.

In FIG. 13, “G_RAW” is a bit error rate when a crosstalk cancellation process is not performed during reproduction of groove recording data.

“L_RAW” is a bit error rate when the crosstalk cancellation process is not performed during reproduction of land recording data.

“G_XTC” is a bit error rate when the crosstalk cancellation process is performed during reproduction of the groove recording data.

“L_XTC” is a bit error rate when the crosstalk cancellation process is performed during reproduction of the land recording data.

It should be noted that Japanese Unexamined Patent Application Publication No. 2012-79385 discloses the crosstalk cancellation process in detail.

As understood from the measurement results of FIG. 13, even when high density recording of 50 GB per layer is performed on the optical disc serving as a sample, reproduction signals of satisfactory quality are obtained by performing the crosstalk cancellation process.

Since the crosstalk cancellation process is necessary in high density recording in practical use, even when the information recording layer 2 has a single film structure with the recording film 2a of a W—Fe oxide, it can respond to high density recording.

### 3-5: Conclusion

Hereinabove, various measurement results of optical discs serving as samples according to embodiments have been described, and the following conclusions can be made.

When the recording film 2a of a W—Fe oxide or a W—(X)—Fe oxide is formed, satisfactory quality of reproduction signals (with i-MLSE and bit error rates) is obtained, and the recording laser power margin is also wide.

There are no problems in the quality of reproduction signals and recording laser power margin in a single film structure, a dual film structure, and a triple film structure. For this reason, the information recording layer 2 can be formed in a simple structure having three or fewer films. Such a simple film structure is advantageous in reduction of manufacturing cost and improvement in manufacturing efficiency.

There was concern in a single film structure in which the protective film 2b is not provided in terms of durability and reliability, but as shown in FIGS. 12A, 12B, and 13, satisfactory durability and reliability are acknowledged.

The film structures according to the embodiment of the present application can also respond to high density recording exceeding that of current BDs.

Based on the above description, an optical disc according to the embodiments can acquire reliability and respond to high density recording as an optical recording medium having an information recording layer with a simple film structure. In addition, such an optical disc can also reduce cost by using an inexpensive material such as Fe for a recording film.

In addition, it is not necessary to separately form a reflective film with appropriate content of Fe, which further contributes to realization of a simple film structure.

In addition, transmittance can be controlled with a content ratio of W:Fe, that enables appropriate application even to a multilayer optical disc.

It should be noted that, in the recording film 2a of a W/Fe oxide, W contributes to an increase in transmittance, and Fe contributes to an increase in recording sensitivity.

With regard to a W—(X)—Fe oxide, as an additional element corresponding to (X), each oxide of Al, Si, Ti, Zn, In, Sn, Zr, or Ga is an additional material assisting the function of W and exhibiting an effect of increasing transmittance.

On the other hand, each oxide of Mn, Ni, Cu, Pd, or Ag is an additional material that assists the function of Fe, boosts absorption, and improves recording sensitivity.

Hereinabove, the embodiments have been described, but the composition of the recording film 2a and the protective film 2b of the information recording layer 2, and the content ratio of W, Fe, and (X) of the recording film 2a are not limited to the example of the samples described above. Various compositions and content ratios may be selected within a practical scope.

In addition, the information recording layer 2 of each optical disc of the embodiments is configured to have a land/groove shape, but a flat information recording layer 2 on which lands and grooves are not formed may be formed.

In addition, the structures of the information recording layer 2 of the present disclosure can be applied not only to optical discs but also to other kinds of optical recording media such as a card-type recording medium.

Additionally, the present application may also be configured as below.

(1) An optical recording medium including:

a substrate;

an information recording layer that is formed on the substrate, and has a recording film including a W oxide and an Fe oxide; and

a light transmissive layer that is formed on the information recording layer.

(2) The optical recording medium according to (1), wherein the recording film includes at least one or more oxides of Al, Si, Ti, Zn, In, Sn, Zr, Ga, Mn, Ni, Cu, Pd, and Ag in addition to the W oxide and the Fe oxide.
(3) The optical recording medium according to (1) or (2), wherein the information recording layer has a single film structure of the recording film.
(4) The optical recording medium according to (1) or (2), wherein the information recording layer has a dual film structure including the recording film and a protective film.
(5) The optical recording medium according to (1) or (2), wherein the information recording layer has a triple film structure including a protective film, the recording film, and another protective film.
(6) The optical recording medium according to any one of (1) to (5), wherein the information recording layer is formed in a land/groove shape.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An optical recording medium comprising:
a substrate;
an information recording layer that is formed on the substrate, and has a recording film including a W oxide and an Fe oxide; and
a light transmissive layer that is formed on the information recording layer.

2. The optical recording medium according to claim 1, wherein the recording film includes at least one or more oxides of Al, Si, Ti, Zn, In, Sn, Zr, Ga, Mn, Ni, Cu, Pd, and Ag in addition to the W oxide and the Fe oxide.

3. The optical recording medium according to claim 1, wherein the information recording layer has a single film structure of the recording film.

4. The optical recording medium according to claim 1, wherein the information recording layer has a dual film structure including the recording film and a protective film.

5. The optical recording medium according to claim 1, wherein the information recording layer has a triple film structure including a protective film, the recording film, and another protective film.

6. The optical recording medium according to claim 1, wherein the information recording layer is formed in a land/groove shape.

7. A manufacturing method of an optical recording medium that includes a substrate, an information recording layer, and a light transmissive layer, the method comprising:
molding the substrate;
forming the information recording layer on the substrate; and
forming the light transmissive layer on the information recording layer,
wherein, in the step of forming the information recording layer, formation of a recording film that includes a W oxide and an Fe oxide using sputtering is included.
